(19) United States
(12) Patent Application Publication
(10) Pub. No.: US 2006/0204642 A1
(43) Pub. Date: Sep. 14, 2006

(54) Reduced-density foodstuff having improved flavor aroma, and mouth feel

(76) Inventors: Leslie N. Adams, Pleasanton, CA (US); John F. Jurcso, Pleasanton, CA (US); Daniel W. Vanderhoof, Pleasanton, CA (US); Michelle Rule, Pleasanton, CA (US)

Correspondence Address: THE CLOROX COMPANY, P.O. BOX 24305, OAKLAND, CA, 94623-1305, US

(21) Appl. No.: 11/076,634

(22) Filed: Mar. 9, 2005

(51) Int. Cl. A23L 1/221

(52) U.S. Cl. 426/650

(57) ABSTRACT

A foodstuff is aerated with a food-safe gas, such as nitrogen, to lower its density and improve various desirable aspects of the foodstuff, such as its mouth feel, flavor, pourability, aroma, and visual appearance, the density of the aerated foodstuff being less than 1.0 g/cc, and more preferably less than 0.95 g/cc.

### FIELD OF THE INVENTION

The present invention relates to foodstuffs, and more particularly this invention relates to a salad dressing-type foodstuff, aerated with a food-safe gas.

### BACKGROUND OF THE INVENTION

Salad dressing foodstuffs are used by millions of people to enhance the flavor of foods ranging from lettuce and vegetables to meats and snacks. Producers of salad dressings are continually working to improve not only the flavor of the foodstuffs, but its other aesthetic properties as well. Among these aesthetic properties are visual appeal, mouth feel, aroma, pourability, etc.

In addition to improving the aesthetic qualities of salad dressings, producers also strive to improve logistic and production costs as well. To that end, it is desirable to reduce the weight per volume, thereby reducing transportation costs.

Aeration with a food-safe gas has been used to reduce the density of bottled and canned foods such as mayonnaise, meat and yogurt. An added benefit of aeration is that the total amount of material per container is reduced, part of the volume being gas. However, aeration does' not necessarily improve aesthetic properties of the food. Particularly, whipping the product typically results in too much aeration, which can actually detract from the desirable aesthetic properties of the food product.

U.S. Pat. No. 4,578,278 describes a method to aerate mayonnaise-type products by producing whipped egg white foam and mixing it with the rest of the ingredients. The resulting product is a viscous mayonnaise.

U.S. Pat. No. 3,615,583 describes a process to make a whipped meat food product whereby the ingredients are blended, pasteurized at 160° F., homogenized, chilled at 35° F. and then increased in volume by at least 15 to 20 percent. The process requires chilling both during aeration and throughout the shelf life.

U.S. Pat. No. 4,948,617 describes a low cholesterol mayonnaise substitute that contains substantially no egg yolk or starch thickeners. The patent describes the flavor and texture improvements achieved using aeration as a substitute of high-cholesterol ingredients. However, the mayonnaise has a much higher viscosity (120,000-180,000 cP at 4 rpm Brookfield viscosity TCD spindle) than salad dressing and is not pourable. Additionally, mayonnaise must have at least 65% oil, whereby salad dressings usually have less than about 65% oil, and many salad dressings average below 50% oil.

U.S. Patent Application Publication No. 2003/0068406A1 describes a process to make whipped yogurt. However, yogurt has a short shelf life and requires refrigeration throughout its shelf life. Moreover, yogurt does not have the pourability and visual appearance characteristics important in salad dressing foodstuffs.

What is needed is an aerated foodstuff, particularly a salad dressing foodstuff, that is less viscous, pourable, aerated but not whipped, and is storable for a multi-month shelf life at room temperature, while having an improved mouth feel, appearance, flavor and aroma.

### SUMMARY OF THE INVENTION

A product and process have been developed wherein salad dressing, a shelf-stable foodstuff with a pourable viscosity, is aerated with nitrogen (or other food-safe gas) to lower its density and improve various desirable aspects of the foodstuff, such as its mouth feel, visual appeal, flavor and aroma.

The foodstuff includes one or more of the following: a thickener or thickener system present at a quantity sufficient to impart a pourable viscosity of less than about 10000 cP on the foodstuff, a stabilizer, an emulsifier, water, less than about 65% percent (%) by weight of an oil, flavoring agents imparting a flavor on the foodstuff (such as “ranch” flavor), a preservative, and a food-safe gas. The food-safe gas may comprise, by way of example and not by way of limitation, nitrogen or other food-safe gases. The food-safe gas is present at a quantity sufficient to create an overrun of less than about 25% as calculated by the following formula:

$$\% overrun = \frac{WB - WA}{WA} \times 100 \% \qquad Equation 1$$

where:

WB=weight of foodstuff per unit volume before (prior to or without) addition of food-safe gas; and

WA=weight of foodstuff per unit volume after addition of food-safe gas.

Aeration has also been found to improve various favorable properties of the foodstuff. For instance, the aeration of the foodstuff with the food-safe gas lowers the density of the foodstuff. In one embodiment, the final density of the foodstuff is less than about 0.95 g/cc. The foodstuff has a higher total aroma, as measured by a smell test, than an otherwise identical foodstuff not having the food-safe gas present. The foodstuff also has a creamier mouth feel, as measured by a mouth feel test, than an otherwise identical foodstuff not having the food-safe gas present. Additionally, the foodstuff is less shiny, as measured by a visual test, than an otherwise identical foodstuff not having the food-safe gas present. Further, the foodstuff has more flavor, as measured by a taste test, than an otherwise identical foodstuff not having the food-safe gas present. Preferably, the foodstuff has a shelf life of at least six months without refrigeration.

Other systems, methods, features, and advantages of the present invention will be or become apparent to one with skill in the art upon examination of the following detailed description. It is intended that all such additional systems, methods, features, and advantages be included within this description, be within the scope of the present invention, and be protected by the accompanying claims.

### DETAILED DESCRIPTION OF THE PREFERRED EMBODIMENTS

Having summarized the invention above, reference is now made in detail to the description of the invention. While the preferred embodiments of the present invention are described, there is no intent to limit the inventive concepts claimed herein. On the contrary, the intent is to cover all alternatives, modifications and equivalents included within the spirit and scope of the invention as defined by the appended claims.

Those skilled in the art will appreciate that many types of foodstuffs are known and presently being marketed. Moreover, those skilled in the art will appreciate that many types of salad dressing foodstuffs are known and are presently marketed. However, what is not known is that by adding a small amount of a food-safe gas to a foodstuff, particularly to a salad dressing-type foodstuff, the foodstuff and the consumer preference for the foodstuff can be significantly improved. It is anticipated that aeration of foodstuffs other than salad dressing-type foodstuffs will result in improvements similar to those described herein.

A product and process have been developed wherein a foodstuff, preferably a salad dressing foodstuff is aerated with nitrogen (or other food-safe gas). Aeration of a foodstuff lowers its density and improves various desirable aspects of the foodstuff. For a preferred salad dressing foodstuff, such improvements include, but are not limited to, the mouth feel, visual appeal, aroma and flavor of the salad dressing foodstuff. In particular, the flavor release of the foodstuff is altered due to the impact of the nitrogen (or other food-safe gas) bubbles that result from the aeration. By controlling the amount of aeration, the mouth feel, visual appeal, aroma, and flavor can be improved while obtaining the advantages associated with reducing the overall density of the foodstuff.

A salad dressing foodstuff according to a preferred embodiment includes one or more of the following: at least one thickener present at a quantity sufficient to impart a pourable viscosity of less than about 10000 centipoises (cP) on the foodstuff, an optional stabilizer, an emulsifier, water, less than 65 percent by weight of an oil, flavoring agents, a preservative, and microbubbles of a food-safe gas distributed throughout the foodstuff. The microbubbles are preferably formed of a bubble size between about 0.1 to 20 microns, and are most preferably formed of a bubble size averaging less than 2 microns. In a preferred embodiment, the microbubbles of the food-safe gas are uniformly or substantially uniformly distributed throughout the foodstuff.

In a preferred embodiment, the thickening agent or agents are used to aid in controlling the viscosity of the foodstuff. For a salad dressing foodstuff, it is desirable to impart a thickness that is sufficient to allow the foodstuff to adhere to the food to which it is applied (e.g., lettuce), yet remain pourable from a container. A preferred viscosity range for salad dressing foodstuffs is about 3000 to about 7500 cP. Thickening agents include starches, as well as edible gums, such as but not limited to, xanthan gum, guar gum, gum tragacanth, gum arabic, locust bean gum, alginates, pectins, or mixtures thereof. One skilled in the art will appreciate that each of the illustrative thickeners has a different thickening effect, and amounts added will thus vary depending on which thickener or thickening system is selected. Such amounts can be readily determined without undue experimentation to achieve a range of desirable viscosities for a foodstuff. The thickening agents are preferably present in the foodstuff in a total amount of about 0.05 to about 2.0 weight percent (wt. %) of the foodstuff.

In a preferred embodiment, stabilizers are used to aid in increasing the microbiological stability of the salad dressing foodstuff. Common stabilizers include, but are not limited to, acidic compounds such as acetic acid, phosphoric acid and/or lactic acid. One skilled in the art will appreciate that each of the illustrative stabilizers may have a different effect upon the foodstuff mixture, and amounts added will thus vary depending on which stabilizer or stabilizers are selected. Such amounts of stabilizer can be readily determined without undue experimentation to achieve a desired microbiological stability for a foodstuff. The stabilizers are preferably present in the foodstuff in an amount of about 0.5 to about 5.0 wt. % of the foodstuff.

In a preferred embodiment, the salad dressing foodstuff contains less than about 65 wt. % oil, and more preferably less than about 50 wt. % oil. One skilled in the art will appreciate that many types of edible oils may be used in the foodstuff product of the invention. For example only, oils of soy, peanuts, cotton, sunflower, rapeseed, grapestones and other edible oils may be used to compose the foodstuff.

The foodstuff can be fabricated as an oil-in-water emulsion. Food grade emulsifiers may include almost any edible emulsifier. By way of example only, and not by way of limitation, emulsifiers may include egg yolks, polyoxyethylene sorbitan fatty acid esters (e.g., polyoxyethylene sorbitan monolaurate [i.e., polysorbate 20], polyoxyethylene sorbitan monostearate [i.e., polysorbate 60], polyoxyethylene sorbitan monooleate [i.e., polysorbate 80], and polyoxyethylene sorbitan tristearate [i.e., polysorbate 65]), polyglycerol esters (e.g., decaglycerol dioleate, decaglycerol mono-dioleate), ethoxylated mono- and di-glycerols, or mixtures thereof. One skilled in the art will appreciate that many different emulsifiers or mixtures thereof may be used to produce a foodstuff having desired emulsion characteristics. The emulsifiers are preferably present in the foodstuff in an amount of about 0.001% to about 5.0 wt. %.

It is common to include flavoring agents in a foodstuff. In a preferred embodiment of a salad dressing foodstuff, the flavoring agents used may include one or more of the following: salt; pepper; sweetening agents; and various seasoning agents and spices. Sweetening agents may include, by way of example only, sugar, glucose, dextrose, lactose, honey, or corn syrup. Spices may include natural and artificial flavors, flavor enhancers, dairy products, and mixtures thereof, for instance, mustard, horseradish, tomato concentrate, pepper, pimento, paprika, onion, garlic and others spices. Additionally, flakes of spices, such as bay leaves, cilantro, chives, celery leaves, etc. can be added for flavoring and/or to add visually appealing speckles. One skilled in the art will appreciate that there is an almost unlimited number and combination of flavoring agents which may be added to a foodstuff to achieve a desired flavor, such as by way of example only, a distinctive “ranch” flavor. These flavorings and spices are preferably present in the foodstuff in an amount of about 0.5 to about 10.0 wt. %.

The salad dressing foodstuff may also include colorings or coloring agents. Colorings that are commonly used include, but are not limited to, betacarotene, egg yolk colorings, oleoresin paprika, and mixtures thereof. Such colorings are present in the foodstuff in an amount of about 0.005 to about 0.05 wt %.

The foodstuff preferably has a shelf life of greater than six months. In a preferred embodiment, the foodstuff has a shelf life of greater than about nine months in an unopened, unrefrigerated state, or several weeks to several months in a refrigerated state. To insure long shelf life, the foodstuff can include preservatives such as sodium benzoate, potassium sorbate, sorbic acid, calcium disodium ethylenediamine tetracetic acid, vinegar, and mixtures thereof. One skilled in the art will appreciate that other preservatives may be used to achieve shelf life for the foodstuff. These preservatives are preferably present in the foodstuff in an amount of about 0.0075 to about 0.50 wt. %.

A food-safe gas is preferably one that has one or more of the following characteristics: does not significantly react with the materials with which it is mixed, does not significantly promote spoilage, and does not present a significant health risk. A preferred food-safe gas includes nitrogen. However, it is envisioned that one of skill in the art will understand that other food-safe gases may be employed in this invention.

Addition of the food-safe gas through aeration of the foodstuff lowers the density of the foodstuff. Moreover, in a preferred salad dressing foodstuff, the aerated foodstuff exhibits an improved mouth feel, an increase in flavor and aroma, an improvement in pourability, and an improved visual appearance. The preferred embodiment of an aerated salad dressing foodstuff further exhibits a fresher taste for a longer period of time than a non-aerated salad dressing foodstuff of the same type.

While not wishing to be bound by any theory, it is believed that the flavor and aroma benefits observed in the aerated foodstuff occur when some aromatic molecules enter the gas bubbles, where they remain until the bubbles “pop” and the gases trapped therein are exposed to the ambient air. The shape of the pocket in the foodstuff remaining after a bubble pops also presents a larger surface area from which aromatics can escape to the ambient-air. Likewise, it is believed that as bubbles of the food-safe gas are released, the gas pocket collapses, allowing flavor molecules to reach the tongue in a time-staggered manner, thereby enhancing the flavor.

A further benefit of the aerated foodstuffs presented herein is found in the density reduction of the product. That is, though the total amount of consumables per container are reduced, the consumer receives an improved experience due to the enhanced flavor, aroma, mouth feel, etc. that the aeration provides. Moreover, benefits of the present aerated foodstuff include reductions in manufacturing and transportation costs. Because the density of the foodstuff is reduced, the total amount of consumables per unit volume is reduced. Thus, the result is a reduction in the raw material costs. Additionally, because the density is reduced, the energy and expense required to transport cases of the foodstuff is reduced, resulting in an overall cost savings.

The foodstuff is aerated with a food-safe gas to create an overrun, thereby lowering its density. In a preferred embodiment of a salad dressing foodstuff, the equation for overrun is set forth below:

$$\% overrun = \frac{WB - WA}{WA} \times 100 \% \qquad Equation 1$$

where:

WB=weight of foodstuff per unit volume before (prior to or without) addition of food-safe gas; and

WA=weight of foodstuff per unit volume after addition of food-safe-gas.

The preferred range of overrun is between about 3 to about 25%. A more preferred range of overrun is between about 3 to about 10%. The most preferred range of overrun is about 3 to about 7%.

Testing

An analysis was conducted on five samples of a ranch flavored salad dressing foodstuff to compare the sensory characteristics of the samples. The five samples included a Store Bought Control of HIDDEN VALLEY® Ranch bottled salad dressing (non-aerated), Fresh Control (from production, non-aerated), 5% Overrun, 10% Overrun, and 15% Overrun). The following testing methods and criteria for evaluating the samples may be implemented for comparing the sensory characteristics.

Smell Test

The five samples are provided to panelists in individual cups without any markings indicating which samples are control or overrun. The panelists smell each sample and rate the intensity of the aroma on a line scale. The stronger the intensity, the higher the mark assigned by the panelist.

An alternative test method begins with one of the control samples being presented to each panelist as a benchmark or baseline. Then the other samples are sequentially presented to the panelists, allowing them to test the aroma of each sample and compare it to the baseline control sample. The panelists then rank each sample as having more aroma or less aroma than the baseline sample.

Regardless of which test method is used, the object of the testing is to determine whether the aroma of the aerated samples (overrun) is stronger or weaker than the aroma of the control samples.

Mouth Feel Test

The five samples are provided to panelists in individual cups without any markings indicating which samples are control or overrun. The panelists place a portion or all of each sample in their mouths and rate the mouth feel on a line scale. The better the mouth feel, the higher the mark assigned by the panelist.

An alternative test method begins with one of the control samples being presented to each panelist as a benchmark or baseline. Then the other samples are sequentially presented to the panelists, allowing them to test the mouth feel of each sample and compare it to the baseline control sample. The panelists then rank each sample as having a more desirable mouth feel or less desirable mouth feel than the baseline sample.

Regardless of which test method is used, the object of the testing is to determine whether the mouth feel of the aerated samples (overrun) have a better or worse mouth feel relative to the control samples. Criteria or guidance can be provided to the panelists, such as a creamier texture provides a better mouth feel than a watery or grainy texture, etc. A creamy mouth feel can be defined as a softer and smoother texture when the foodstuff is moved about the mouth by the tongue, as opposed to a more watery, grainy, or gummy (thick, pudding-like) feel. Other criteria can include viscosity in the mouth, or any other characteristic pertaining to the feel of the samples when placed in one's mouth.

Taste Test

The five samples are provided to panelists in individual cups without any markings indicating which samples are control or overrun. The panelists taste each sample and rate the overall taste on a line scale. The better the taste, the higher the mark assigned by the panelist.

An alternative test method begins with one of the control samples being presented to each panelist as a benchmark or baseline. Then the other samples are sequentially presented to the panelists, allowing them to taste each sample and compare it to the baseline control sample. The panelists then rank each sample as having a better taste or less desirable taste than the baseline sample.

Regardless of which method is used, the object of the testing is to determine whether the taste of the aerated samples (overrun) is better than or less desirable relative to the control samples. A consumable, e.g., water, bread, etc., can be provided between tastings to clean the palate of the panelists.

Visual Test

The five samples are provided to panelists in individual cups without any markings indicating which samples are control or overrun. The panelists look at each sample and rate the visual appearance on a line scale. The better the appearance, the higher the mark assigned by the panelist.

An alternative test method begins with one of the control samples being presented to each panelist as a benchmark or baseline. Then the other samples are presented to the panelists, allowing them to compare the visual appearance to the baseline control sample. The panelists then rank each sample as having a more desirable appearance or less desirable appearance than the baseline sample.

Regardless of which test method is used, the object of the testing is to determine whether the appearance of the aerated samples (overrun) is better or worse relative to the control samples. Criteria or guidance can be provided to the panelists, such as a creamier appearance is an improvement over a shiny appearance, fewer visual air bubbles are better, the appearance of the samples during pouring, etc.

Additional Tests/Variations

One skilled in the art will appreciate that other types of testing can be conducted by merely varying the parameters of the above-described tests or devising additional tests to reflect the desired property to be tested.

Preference for Overrun Samples Versus the Control Samples

The results of the testing for the overrun samples as compared to the control samples, showed an overall preference for the aerated foodstuff. In particular, the 5% Overrun was most preferred over the controls and also over the 10% Overrun and the 15% Overrun. The 5% Overrun, as compared with controls, was higher in Total Aroma, higher in Total Onion/Garlic aroma and flavor, higher in Onion aroma, higher in Garlic aroma, higher in number of Air Bubbles, and was less shiny than the controls. The viscosity of the 5% Overrun was preferred in the Viscosity when pouring and Viscosity over lettuce tests, showing improved pourability of the salad dressing foodstuff.

Across the three overrun samples, 5% Overrun was highest in Total Aroma, higher in Cultured Dairy aroma than 15% Overrun, highest in Total Onion/Garlic aroma and flavor, Onion aroma, Garlic aroma, higher in Fresh Green Herb aroma than 10% Overrun, lower in Viscosity when pouring than 10% Overrun, lowest in Air Bubbles, least Shiny, higher in Particle Size than 15% Overrun, highest in Total Flavor and Total Aftertaste, highest in Cultured Dairy, highest in Total Herb and Fresh Green Herb flavor, highest in Viscosity by mouth, Density, and Creamy Mouth Feel.

The 5% Overrun sample was preferred over the control samples and was also preferred over the 10% Overrun and 15% Overrun samples. On Overall Flavor, Appearance, Overall Texture, Immediate Strength of Flavor when First in Mouth, Thickness of Dressing in Mouth, the 5% Overrun sample significantly outperformed and was strongly preferred over controls, and was preferred over the other overrun samples.

Comparative Densities

In a preferred embodiment of 5% Overrun, a ranch salad dressing foodstuff, specifically HIDDEN VALLEYS Ranch pourable salad dressing, has a density of less than about 0.95 g/cc. As compared with other commercially available full fat and light ranch dressings, the 5% Overrun is significantly less dense. Below is a chart comparing both full fat 5% Overrun HIDDEN VALLEYS Ranch salad dressing and reduced fat 5% Overrun HIDDEN VALLEY® Ranch salad dressing to competing ranch-style foodstuffs.

FULL FAT RANCH SALAD DRESSINGS

| Salad Dressing | Product Density g/cc |
|---|---|
| Ranch with 5% Overrun | 0.95 |
| Kraft ® Ranch | 0.9952 |
| Wishbone Ranch | 0.9866 |
| Ken's Steak House Ranch | 0.9786 |
| Garden Goodness Ranch | 1.0139 |
| Wishbone Ranch Up Classic | 0.9989 |
| Wishbone Carp Options | 0.97 |
| Kraft Carb Well Ranch | 0.9644 |
| Hidden Valley ® Buttermilk Ranch | 0.9831 |
| Kraft Buttermilk Ranch | 0.9884 |

LIGHT RANCH SALAD DRESSINGS

| Salad Dressing | Product Density g/cc |
|---|---|
| Light Ranch with 5% Overrun | 0.95 |
| Kraft Light Done Right | 1.086 |
| Wishbone Just 2 Good Ranch | 1.0828 |
| Wishbone Ranch Up Light | 1.0939 |
| Garden Goodness Light Ranch | 1.002 |
| Ken's Steak House Lite Ranch | 1.0062 |

Thus, the density of the 5% Overrun is shown to be significantly less than that of competing ranch salad dressing foodstuffs. Accordingly, the benefits of aeration with food-safe gas and the density reduction are anticipated, including, but not limited to, improved mouth feel, flavor, aroma, pourability, and visual appearance.

### EXAMPLES

### Example 1

HIDDEN VALLEY® Ranch salad dressing is aerated with nitrogen gas to 5% Overrun. The resulting aerated salad dressing is shelf-stable for at least 9 months and has a pourable viscosity of about 3000 to about 7500 cP. The 5% Overrun has reduced density and improved mouth feel, flavor, aroma, pourability, and visual appearance.

### Example 2

Spices selected to provide a ranch flavor are added to an oil-in-water emulsion to create a ranch-style salad dressing foodstuff containing less than 50% by weight oil. Additional ingredients include at least one thickener, a stabilizer, an emulsifier, a preservative, and a dairy product. The thickness is present at a quantity sufficient to impart a pourable viscosity of less than about 10000 cP on the foodstuff as finally packaged. The preservative provides a shelf life of at least 3 months, preferably greater than 6 months, and most preferably greater than 9 months. The foodstuff is aerated with nitrogen gas to an overrun of 5-10%.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A foodstuff having improved mouth feel, taste, and aroma, and a lowered density, comprising:
at least one thickener present at a quantity sufficient to impart a pourable viscosity of less than about 10000 cP on the foodstuff;
less than 65 percent by weight of an oil;
flavoring agents; and
nitrogen present at a quantity sufficient to create an overrun of less than about 10 percent as calculated by the following formula:
$$\% overrun = \frac{WB - WA}{WA} \times 100 \%$$
where:
WB=weight of foodstuff per unit volume before (prior to or without) addition of food-safe gas; and
WA=weight of foodstuff per unit volume after addition of food-safe gas; wherein a density of the foodstuff is less than about 0.95 g/cc;
wherein optionally the foodstuff has a higher total aroma than an otherwise identical foodstuff not having the nitrogen present as measured by a smell test;
wherein optionally the foodstuff has a creamier mouth feel than an otherwise identical foodstuff not having the nitrogen present as measured by a mouth feel test;
wherein optionally the foodstuff is less shiny than an otherwise identical foodstuff not having the nitrogen present as measured by a visual test;
wherein optionally the foodstuff has more flavor than an otherwise identical foodstuff not having the nitrogen present as measured by a taste test;
wherein optionally the foodstuff has a shelf life of at least six months.

2. A foodstuff, comprising:
water;
a thickener;
a stabilizer;
less than 65 percent by weight of an oil;
flavoring agents; and
a food-safe gas present at a quantity sufficient to create an overrun of less than about 25 percent as calculated by the following formula:
by the following formula:
$$\% overrun = \frac{WB - WA}{WA} \times 100 \%$$
where:
WB=weight of foodstuff per unit volume before (prior to or without) addition of food-safe gas; and
WA=weight of foodstuff per unit volume after addition of food-safe gas.

3. A foodstuff as recited in claim 2, wherein the foodstuff is of a salad dressing type.

4. A foodstuff as recited in claim 3, wherein the foodstuff is a “ranch” type salad dressing.

5. A foodstuff as recited in claim 2, wherein the overrun is less than about 10%.

6. A foodstuff as recited in claim 2, wherein the overrun is between about 3% and about 7%.

7. A foodstuff as recited in claim 2, wherein the overrun is about 5%.

8. A foodstuff as recited in claim 2, wherein the foodstuff has a shelf life of at least 6 months.

9. A foodstuff as recited in claim 2, wherein the foodstuff has a shelf life of at least 9 months.

10. A foodstuff as recited in claim 2, wherein the food-safe gas is nitrogen.

11. A foodstuff as recited in claim 2, wherein the foodstuff has a higher total aroma than an otherwise identical foodstuff not having the food-safe gas present as measured by a smell test.

12. A foodstuff as recited in claim 2, wherein the foodstuff has a creamier mouth feel than an otherwise identical foodstuff not having the food-safe gas present as measured by a mouth feel test.

13. A foodstuff as recited in claim 2, wherein the foodstuff is less shiny than an otherwise identical foodstuff not having the food-safe gas present as measured by a visual test.

14. A foodstuff as recited in claim 2, wherein the foodstuff has more flavor than an otherwise identical foodstuff not having the food-safe gas present as measured by a taste test.

15. A foodstuff as recited in claim 2, wherein a density of the foodstuff is less than about 1.0 g/cc.

16. A foodstuff as recited in claim 2, wherein a density of the foodstuff is less than about 0.95 g/cc.

17. A method for improving a foodstuff, comprising:
aerating a foodstuff with a food-safe gas to an overrun of less than about 25%, wherein the overrun is calculated according to the following formula:
$$\% overrun = \frac{WB - WA}{WA} \times 100 \%$$
where:
WB=weight of foodstuff per unit volume before (prior to or without) addition of food-safe gas; and
WA=weight of foodstuff per unit volume after addition of food-safe gas.

18. A method as recited in claim 17 for providing an aerated foodstuff, wherein the foodstuff is a “ranch” type salad dressing.

19. A method as recited in claim 17 for providing an aerated foodstuff, wherein the food-safe gas is nitrogen.

20. A method as recited in claim 17 for providing an aerated foodstuff, wherein the foodstuff has a creamier mouth feel than an otherwise identical foodstuff not having the food-safe gas present as measured by a mouth feel test.

21. A method as recited in claim 17 for providing an aerated foodstuff, wherein the foodstuff has a higher total aroma than an otherwise identical foodstuff not having the food-safe gas present as measured by a smell test.

22. A method as recited in claim 17 for providing an aerated foodstuff, wherein the foodstuff is less shiny than an otherwise identical foodstuff not having the food-safe gas present as measured by a visual test.

23. A method as recited in claim 17 for providing an aerated foodstuff, wherein the foodstuff has more flavor than an otherwise identical foodstuff not having the food-safe gas present as measured by a taste test.

24. A method as recited in claim 17 for providing an aerated foodstuff, wherein a density of the foodstuff is less than about 1 g/cc.

25. A method as recited in claim 17 for providing an aerated foodstuff, wherein a density of the foodstuff is less than about 0.95 g/cc.

26. A food-safe gas-aerated foodstuff having consumer-preferred mouth feel, taste and aroma, wherein
a density of said foodstuff is less than about 1.0 g/cc; and
an oil content of said foodstuff is less than about 65 percent by weight

27. The aerated foodstuff of claim 26 wherein the foodstuff is aerated with nitrogen.

28. The aerated foodstuff of claim 27 wherein the nitrogen forms microbubbles within the foodstuff, said microbubbles having a preferred size of between 0.1-20 microns.

29. The aerated foodstuff of claim 28 wherein the microbubbles are substantially uniformly distributed throughout the foodstuff.

30. The aerated foodstuff of claim 26 wherein the density of said foodstuff is less than about 0.95 g/cc.

31. The aerated foodstuff of claim 26 wherein the oil content of said foodstuff is less than about 50 percent by weight.
